(19) United States
(12) Patent Application Publication
(10) Pub. No.: US 2010/0291943 A1
(43) Pub. Date: Nov. 18, 2010

(54) Method and Apparatus for Pooling Network Resources

(76) Inventors: Attila Mihaly, Dunakeszi (HU); Gabor Toth, Szigetszentmiklos (HU); Lars Westberg, Enkoping (SE)

Correspondence Address: COATS & BENNETT, PLLC, 1400 Crescent Green, Suite 300, Cary, NC, 27518, US

(21) Appl. No.: 12/863,897

(22) PCT Filed: Jan. 23, 2008
(86) PCT No.: PCT/EP08/50747

§ 371 Date: Jul. 21, 2010

(51) Int. Cl. H04W 72/04

(52) U.S. Cl. 455/450

(57) ABSTRACT

A method and apparatus for selecting a network resource from a plurality of network resources in a communications network. A selection node receives a request for a network resource from a terminal, and then retrieves, from at least one further network node, data relating to the plurality of network resources. On the basis of the retrieved data, the selection node selects a network resource from the plurality of network resources. A response is then sent to the terminal, the response including information identifying the selected network resource.

### TECHNICAL FIELD

The present invention relates to a method and apparatus for use in a communications network, and in particular to a method and apparatus for allocating pooled server or gateway nodes to a terminal.

### BACKGROUND

Communications networks such as Global System for Mobile communications (GSM) and 3G use gateway nodes to allow a Mobile Terminal (MT) to access communications networks, and server nodes to provide services to the MT. Server and gateway nodes are frequently “pooled” in a network, to allow load sharing and balancing between pool members, along with increased availability and better utilization of resources. Conventionally, pools are either statically configured, and static pooling can also be based on the Domain Name System (DNS).

Statically configured pools are based on the concept of statically pre-configuring information about selectable server/gateway nodes for a given service. This pre-configured information is stored in each MT, and other nodes that may require this information. When a MT wishes to select a server or gateway, selection algorithms are used to make the selection. Statically configured pools provide load distribution between nodes of similar functionality, increased availability and simplified node dimensioning due to better traffic estimates in large geographical regions.

Static pooling of server and gateway nodes is extensively used in current mobile systems. In 3G networks, Serving GPRS Support Nodes (SGSN) and Mobile Switching Centres (MSC) are pooled using Iu-flex. In GSM networks, these nodes are pooled using A-flex and Gb-flex.

Iu-flex is described in 3GPP in Release 5 TS 23.236, and allows Radio Network Controllers (RNCs) to select an MSC from a pool of MSCs and a SGSNs from a SGSN pool. The same concept is used in GSM, in which a Base Station Controller (BSC) can select an MSC from a pool of MSCs (using A-flex) and a SGSNs from a SGSN pool (using Gb-flex). Sets of core network nodes from which an access network node may choose are referred to as pools or clusters.

Using Iu/A/Gb-flex, pools of MSCs and SGSNs may serve a service area. In this case, all RNCs (or BSCs for GSM) are connected to all MSCs/SGSNs, and vice versa. These connections may be “physical” through direct links, “logical” through SDH VPs or ATM PVCs, or “virtual” through IP connectivity. The service area of a pool is termed a “pool service area”.

When a mobile station (MS) attaches or roams to a pool service area it is assigned a specific MSC/SGSN according to a load distribution algorithm. The MS is not aware of the identities of other members of the pool, and uses the selected MSC or SGSN for all communications whilst the MS remains in the pool service area. Note, however, that if the MS leaves the pool service area and subsequently re-attaches, it may be assigned a different MSC/SGSN according to the network requirements at the time the MS re-attaches.

RNCs and BSCs route messages according to configured tables. A MS can signal to the RND/BCS that a node is unavailable, in which case the RNC/BSC may select a different node for the MS depending on the load balancing requirements of the network.

Another type of statically configured pooling is DNS-based pooling. Rather than configuring pools in each node that may require this information, the configuration is performed in a DNS server. A MS sends a DNS query to the DNS server, which returns a list of IP addresses identifying members of a MSC/SGSN pool. The MS then selects one address from the list based on an internal selection algorithm.

A refinement of this idea is for the DNS server to introduce limited selection before sending the list of IP addresses to the MS. Examples of these are “sort lists” and “round robins”. A Sort List is a DNS feature where the order of addresses in the list of IP addresses are ordered based on the source address of the query. A Round Robin is a DNS feature to balance traffic between two or more addresses. Round Robin is used in General Packet Radio Services (GPRS) networks to distribute the load between multiple Gateway GPRS Support Nodes (GGSNs).

A disadvantage to using Sort Lists in the DNS server is that there is no guarantee that the original order will always be maintained as the information is passed from DNS server to DNS server. To ensure the correct order is maintained, Sort Lists must be configured in all the DNS servers in a network, adding considerable complexity to large DNS solutions. In some cases it may not be possible to set Sort Lists on all servers.

Round Robin operates using static information obtained from a DNS database. The status and actual load on a node are not taken into account when the DNS server responds to a request. Round Robin may override the structure of a response sent from an authoritative server or the effect of a Sort List.

DNS pooling also enables service-specific selection through the usage of the so-called resource records (RR). In the basic DNS server described in IETF RFC 1034/1035, pools can be configured with multiple “address” RRs (A RR) for a given host name. When the DNS server receives a request for a list of addresses, it returns all RRs matching the query. Choosing the one to be used is the clients' task.

A more enhanced service-based pooling solution is specified in RFC 2782, which describes a SRV RR-enabled DNS server. Server pools are configured using multiple “service” resource records (SRV RRs) for a service. A RR format also includes PRIO and WEIGHT parameters. The DNS server's response to a request contains all possible choices of server with priority and weight info, allowing the MS to make a server selection on the basis of pre-defined rules based on the received priority and weight parameters.

An example of DNS-based pooling in mobile networks is GGSN pooling. When a MS attaches to a network, as part of the connection establishment process (Activate PDP context request) in GSM and 3G networks, an SGSN sends a DNS query in order to locate the GGSN that has a connection to the Packet Data Network (PDN), which is identified by the Access Point Name (APN) in the request sent by the MS. The DNS server has a database that maps an APN string to the IP address of the GGSN node. If multiple GGSNs are connected to the same external PDN, the DNS server returns multiple entries in the response sent to the SGSN. The SGSN chooses the first address (if more than one was returned) contained in the DNS response and sends a Create PDP Context Request on the Gn interface to the GGSN node. This procedure makes it possible to implement load sharing between GGSN nodes connected to the same PDN (which can be considered to be a GGSN pool). Configuration of “GGSN pools” is done locally in the DNS.

DNS pooling has certain drawbacks. DNS pooling uses a static database, and so each affected node must be reconfigured in the event of a change in the network topology. Furthermore, a DNS server has no way of knowing the status of an address associated with an APN. A DNS server returns an address regardless of the GGSN status. Standard DNS servers also indiscriminately return all addresses associated with a name, resulting in an inefficient routing of GGSN GTP connections. DNS may direct a SGSN to a more distant GGSN even though a local GGSN could provide access to the same external PDN. As GPRS networks grow in size and complexity intelligent services will be needed. A solution has been developed, as illustrated in FIG. 1, in order to address some of these issues.

The solution illustrated in FIG. 1 provides monitoring of key information in a mobile network and dynamically altering DNS responses to direct an SGSN 101 to a GGSN 102, 103, 104 that is reachable, closer in terms of the network architecture, and can route traffic to the PDN. The features include:

1. Status Monitoring, which checks if GGSNs 102, 103, 104 are reachable over the Gn network, ensures that the traffic can flow through a GGSN to the PDN on the Gi interface and back after a GTP tunnel has been established, and if GGSNs 102, 103, 104 use external services such as RADIUS for authentication or DHCP to assign addresses, then the state of these services is monitored and reported.
2. Load Monitoring, which make it possible to optimize the number of connections for each GGSN 102, 103, 104. GGSNs 102, 103, 104 may have different capacities. DNS load balancing techniques like Round Robin distribute PDP Contexts evenly, which can resulting in the overloading of lower capacity GGSNs. Load values are preconfigured in a server to reflect the different capacities of the GGSNs 102, 103, 104 or alternatively load information is monitored by polling each GGSN 102, 103, 104 for attributes such as CPU utilization, packet throughput, number of connections, etc.

Actual monitoring techniques may differ from network to network and from operator to operator. Active monitors using ICMP ECHO, SNMP gets, or GTP probes can be used to report status and load. For situations where monitoring a service such as RADIUS is required, intelligent monitors that utilize the RADIUS protocol can be used. These more advanced monitors can be used to verify that a service is running and determine whether or not the service is performing the tasks required by the mobile network.

In situations where active monitoring adds unwanted network traffic, passive monitoring is used to evaluate the state of the network by listening to traffic for relevant messages. Such messages include route advertisements, keep alive messages, SNMP traps, etc. For example OSPF, RIP or BGP route announcements can be monitored for key IP addresses like the GTP VIP. When the route for one of these addresses is determined to be unreachable, the DNS server is notified.

By combining filtering rules with status and load information, an optimized list of GGSNs 102, 103, 104 is sent to the SGSN 101. Three main types of traffic steering apply to mobile networks, as follows:
(1) Status: When the SGSN 101 send a DNS query for an APN, IP addresses for GGSNs that are unavailable are removed. If an unavailable GGSN becomes available once more, the GGSN is automatically added to the list of GGSNs in a response.
(2) Location: Using the source IP address of the query, the SGSN 101 making the request can be determined and remote GGSNs filtered out. In this way, the SGSN 101 is always directed to a GGSN in the same POP or region. This limits the number of addresses sent to the SGSN 101.
(3) Load: By using load information obtained by monitoring a node, the load between nodes can be balanced, and the load adjusted for a specific node.

The system architecture of future mobile networks, referred to as System Architecture Evolution (SAE) or Long Term Evolution (LTE) is under development (see 3GPP TS 23.401 (S2-070591) V 0.2.1, “3GPP System Architecture Evolution: GPRS enhancements for LTE access; Release 8”). A proposed architecture is illustrated schematically in FIG. 2. The central core node in this architecture can have physically separated user and control plane (i.e. split-architecture). In the split architecture model, the following entities are defined:
(1) The Mobility Management Entity (MME) 201 handles control plane signalling and it is responsible for mobility.
(2) The SAE Gateway (SAEGW) is separated into Serving SAEGW 202 and PDN SAEGW 203 functionalities terminating the interface towards EUTRAN and PDN, respectively. The PDN SAEGW 203 and the Serving SAEGW 202 may be implemented in one physical node or separated physical nodes. In the latter case there is a tunnelling of user plane traffic between the two nodes via GTP or IETF tunnels (Proxy MIP).

Serving SAEGW 202 functions include:
The local Mobility Anchor point for inter-eNodeB handover;
Mobility anchoring for inter-3GPP mobility (terminating S4 and relaying the traffic between 2G/3G system and PDN SAE GW); and
Lawful Interception

PDN SAEGW functions include:
Policy Enforcement;
Per-user based packet filtering (by e.g. deep packet inspection);
Charging Support; and
Lawful Interception.

The interface S1 provides access to Evolved RAN radio resources for the transport of user plane and control plane traffic and it includes S1_MME 204 and S1_U 205. The S1 reference point enables MME and SAEGW separation and also deployments of a combined MME 201 and Serving SAEGW 202 solution.

The concept of pooling is mentioned in the SAE/LTE document for the core network nodes (MMEs 201 and SAEGWs 202, 203) in order to reduce capacity, to increase reliability and to allow for simplified planning. MME pooling is a mechanism by which a Node B can handle multiple MMEs as if they were a single logical entity. When a MT requests a service, a mechanism selects one of the physical MME nodes and binds the MT to the selected MME. A similar pooling concept is defined for user plane nodes. For example, when a MT attaches to the network, it is the task of the MME (or other control plane entity) to select a given pair of serving/PDN SAEGWs 202, 203 from the pool, and so MTs (and Node Bs) do not see difference between SAEGWs within the same pool.

The User Plane (SAEGW) and Control Plane (MME) pool areas need not necessarily be the same, and can be affected by any of:
The extent of the IP connectivity needed for User Plane traffic on S1, relative to the connectivity needed within the MME Pool Area;
The existence of S1 connectivity across regional borders in a regionalized network;
The number of MMEs and eNodeBs with which an SAEGW must interact; and
In what situations SAEGW relocation will occur

It is likely that different network operators will choose different scenarios for MME/SAEGW pool design, depending on the size of their network, connectivity constraints (e.g., due to regional administration), mobility patterns, etc. A potential SAE architecture for pooling/selection should be able to cope with all different possibilities of pool selection.

The main problem with static pooling is that the pools must be configured on multiple nodes. Maintaining pooling details therefore requires a considerable amount of configuration work. For example, if a network is extended it may require re-design of the existing pools and thus re-configuration of not only the newly introduced hosts, but also the existing ones. Similarly, changes in topology, service network, etc require re-configuration.

A common problem of the static and DNS-based pooling solutions is the lack of information available about dynamic network changes, such as a server being unavailable or a change in the network topology. The solution illustrated in FIG. 1 partly solves that problem but still exhibits a number of deficiencies:
There is only limited topology information available. Even with a filtering function implemented for GGSN selection, there is an ambiguity when no local, but multiple far GGSNs are available. In order that the selection of local GGSNs works, the requestor for a server/gateway from the pool should be the IP host itself. In certain SAE scenarios, this is not possible: for example, it would not work for the SAEGW selection, which should be done by MME based on a request from the eNodeB.
Load information about the transport network is not available and can therefore not be taken into account in the selection process. Thus, some parts of the transport network may become overloaded; others may remain un-utilized depending on the user activity in the different regions. As a consequence, QoS requirements for a given service cannot be guaranteed
Reachability information of servers/gateways from the pool is insufficient. Ping is used to verify whether the given element is reachable from the DNS server, but there is no information about whether it is reachable from the perspective of the communicating MS.
Other characteristics of the pool elements cannot be taken into account. Examples of such characteristics include connectivity to specific networks, supported services etc. All pool elements must be configured similarly and have all required features.
Static pool configuration in DNS is used. In future, the number and capability (e.g. IPSec support, access-type support etc.) of different SAEGW nodes will increase, making configuration management of pools more cumbersome than it currently is. In this scenario, adding and removing SAEGWs (dynamically) to/from a certain pool may become a frequent event, affecting configuration significantly.

### SUMMARY

The inventors have realised the problems and limitations inherent in the static provisioning of pooling information for network resources such as servers and gateways. According to a first aspect of the invention, there is provided a method for selecting a network resource from a plurality of network resources in a communications network. A selection node receives a request for a network resource from a terminal, and then retrieves, from at least one further network node, data relating to the plurality of network resources. On the basis of the retrieved data, the selection node selects a network resource from the plurality of network resources. A response is then sent to the terminal, the response including information identifying the selected network resource. The central selection of network resources reduces the need to configure selection functionality in many different network nodes and improves the efficiency of using pooled network resources.

As an option, the network resource is selected from one of a server or gateway function. The data relating to the plurality of network resources is optionally retrieved from at least one database. The data comprises information relating to the status and capabilities of each network resource of the plurality of network resources. This allows the selection node to make a selection based on the capabilities of each network resource, and select the most suitable network resource for the terminal. The database is optionally dynamically updated as the capabilities and status of each network resource of the plurality of network resources changes, to ensure that the selection node receives the most up-to-date information about the network resources and their availability.

As a further option, the data relating to the plurality of network resources is any of a topology of each network resource in the network, a current load on each network resource, and a current capacity of the network on a path between the terminal and the network resource. This sort of information can be obtained without recourse to a database and gives the selection node information about current network conditions.

As an option, the method comprises retrieving from a Domain Name Server identities for each network resource of the plurality of network resources.

Optionally, the method further comprises retrieving, from a Home Subscriber Server, subscription and service information relating to a user or the terminal. This allows a network resource to be selected on the basis of the user's subscription or terminal's capabilities.

The request and the response are optionally Domain Name System messages. This allows the invention to be easily integrated with existing networks.

The retrieved data optionally comprises information selected from any of:
a location on the network of each of the plurality of network resources;
routing information for each of the plurality of network resources;
current load on each of the plurality of network resources;
current capacity of each of the plurality of network resources;
current network capacity on a path between the terminal and each of the plurality of network resources;
security information relating to each of the plurality of network resources;
services available from each of the plurality of network resources;
subscription information relating to a user or the terminal; and
operator policy information.

When selecting a network resource, the method optionally comprises discounting those network resources from the plurality of network resources that do not fulfil requirements of reachability or available services. In this way, unavailable or unsuitable network resources are not sent to the terminal.

When selecting a network resource, the method optionally includes balancing the load on network resources of the plurality of network resources. This ensures that network resources are used more efficiently, and reduces the risk of overload on one network resource whilst another is being under-used.

Optionally, the response to the terminal entity comprises an IP address of the network resource.

The communications network is optionally selected from a System Architecture Evolution network and an IP Multimedia Subsystem network.

According to a second aspect of the invention, there is provided a selection node for use in a communications network. The selection node comprises a receiver for receiving a request from a terminal for a network resource, and means for retrieving, from at least one further network node, data relating to a plurality of network resources. The selection node further comprises means for selecting a network resource from a plurality of network resources on the basis of the retrieved data, and a transmitter for sending a message to the terminal, the message including information identifying the selected network resource. The selection node reduces the need to configure selection functionality in many different network nodes and improves the efficiency of using pooled network resources.

Optionally, the means for retrieving data comprises means for retrieving data from a plurality of network nodes, as information from a variety of sources may be relevant to the selection process.

The network resource is optionally selected from one of a server or gateway function.

Optionally, the means for retrieving data relating to the plurality of network resources comprises means for retrieving data from at least one database, the data comprising information relating to the status and capabilities of each network resource of the plurality of network resources. As a further option, the means for retrieving data relating to the plurality of network resources comprises means for retrieving any of a topology of each network resource in the network, a current load on each network resource, and a current capacity of the network on a path between the terminal and the network resource. In this way information can be obtained that informs the selection node of current network conditions and information stored about the network resources.

The retrieved data optionally comprises information selected from any of a location on the network of each of the plurality of network resources, routing information for each of the plurality of network resources, current load on each of the plurality of network resources, current capacity of each of the plurality of network resources, current network capacity on a path between the terminal and each of the plurality of network resources, security information relating to each of the plurality of network resources, services available from each of the plurality of network resources, subscription information relating to a user or the terminal, and operator policy information.

The selection node optionally comprises means for discounting those network resources from the plurality of network resources that do not fulfil requirements of reachability or available services, to prevent unsuitable or unavailable network resources from being selected. The selection node optionally comprising means for balancing the load on network resources of the plurality of network resources, to reduce that risk that the network resources are not overloaded or under-used.

According to a third aspect of the invention, there is provided a terminal for use in a communications network. The terminal comprises a processor for generating a request message for a network resource, the request message comprising a Domain Name System query, the Domain Name System query further comprising the identity of the terminal encoded in a Fully Qualified Domain Name. By sending the request message in the form of a DNS query, the message can be forwarded directly to a DNS server, reducing the processing required for processing the message at various network nodes. Furthermore, by encoding the identity of the terminal in a FQDN, the terminal can be identified by a selection function even if the selection function is receiving signalling from a host communicating on behalf of the terminal.

### BRIEF DESCRIPTION OF THE DRAWINGS

FIG. 1 illustrates schematically in a block diagram a DNS architecture;

FIG. 2 illustrates schematically in a block diagram a proposed SAE/LTE architecture;

FIG. 3 illustrates schematically in a block diagram a network architecture according to an embodiment of the invention;

FIG. 4 is a flow diagram illustrating the steps of an embodiment of the invention;

FIG. 5 illustrates schematically in a block diagram a system for selecting a pool of servers or gateways according to an embodiment of the invention;

FIG. 6 illustrates schematically in a block diagram a network architecture for identification of topology, status, capability and functional information of node in a pool according to an embodiment of the invention;

FIG. 7 illustrates schematically in a block diagram terminal attachment in a SAE network according to an embodiment of the invention;

FIG. 8 is a signalling sequence diagram for terminal attachment according to an embodiment of the invention;

FIG. 9 is a signalling sequence diagram illustrating the selection of an IMS-based multi-media service according to an embodiment of the invention;

FIG. 10 illustrates schematically in a block diagram a selection logic function node according to an embodiment of the invention; and

FIG. 11 illustrates schematically in a block diagram a terminal according to an embodiment of the invention.

### DETAILED DESCRIPTION

The following description sets forth specific details, such as particular embodiments, procedures, techniques, etc. for purposes of explanation and not limitation. In some instances, detailed descriptions of well known methods, interfaces, circuits, and devices are omitted so as not obscure the description with unnecessary detail. Moreover, individual blocks are shown in some of the drawings. It will be appreciated that the functions of those blocks may be implemented using individual hardware circuits, using software programs and data, in conjunction with a suitably programmed digital microprocessor or general purpose computer, using application specific integrated circuitry, and/or using one or more digital signal processors.

The following description discloses an enhanced gateway/server selection concept in a SAE/LTE system. However, it will be appreciated that the concept may be used in other types of network. The concept enables automatic selection of the most appropriate server or gateway for a communicating host from a plurality of network resources.

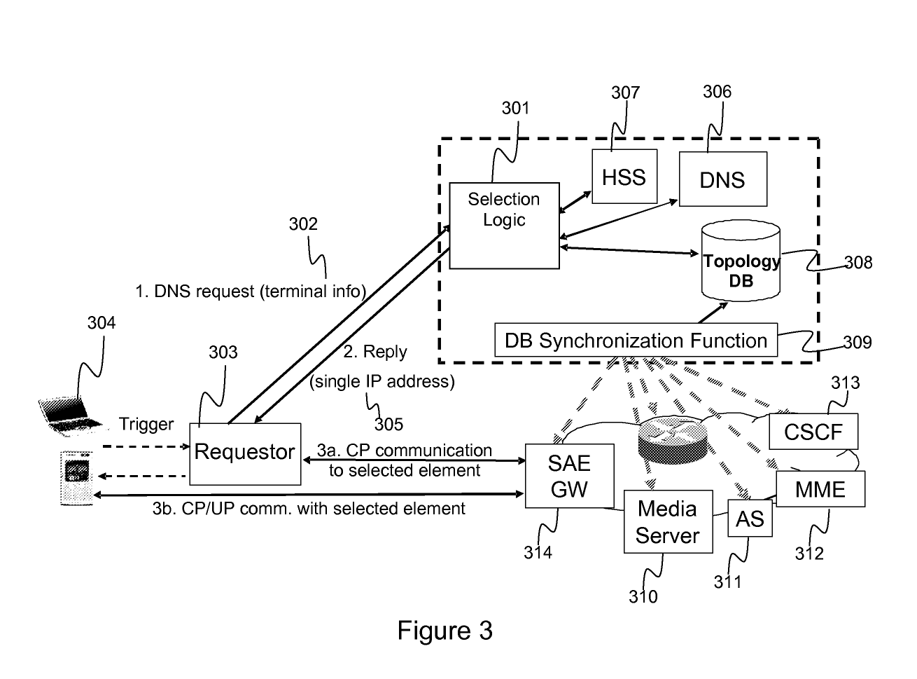

FIG. 3 herein illustrates the high level architecture of a network according to an embodiment of the invention. A selection logic function 301 is provided that receives a DNS request 302 for a server or a gateway from a requestor 303. Note that the requestor 303 and the IP host that needs a server/gateway IP address for communication may not be the same entity, in which case, information identifying the communicating host 304 is conveyed in the request message. The selection logic 301 selects the most appropriate server/gateway for the host 304 based on the criteria such as status (load and reachability), capability, functionality, transport information and service-specific information such as subscription information, minimum Quality of Service etc., and returns 305 a single IP address (that of the selected server/gateway) to the requestor 303. The selection logic 301 is able to obtain information from a number of data sources to infer necessary parameters needed for selection. These data sources include a DNS 306 for retrieving the list of potential servers/gateways for a given service, a Home Subscriber Server (HSS) 307 for retrieving subscription and service-related information, and a Topology database 308 for topology information as well as status/functionality/capability information of pool members.

The queries to the data sources may be triggered by the request from the requestor 303, but the selection logic 301 may initiate queries independently in advance, in order to shorten response time.

The topology database 308 is dynamically updated by a Database synchronization function 309. The Database synchronization function 309 has the following functions:
Topology discovery. The Database synchronization function 309 discovers the topology and link/router status information including the location of servers 310, 311, 312, 313 and gateways 314;
Supervision function. The Database synchronization function 309 is responsible for obtaining the status, capability (e.g., VPN configuration), functionality (e.g., security gateway) and load information of transport nodes as well as pool members.
Resource administration. he Database synchronization function 309 is responsible for administering transport resources in order to provide a balanced transport load and therefore higher session completion ratios.

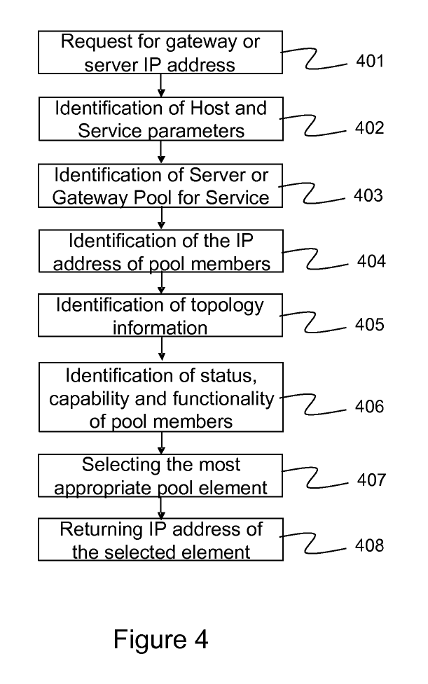

FIG. 4 is a flowchart illustrating an example method for selecting the most appropriate server/gateway from a pool of multiple servers/gateways based on the service information, status and capability/functionality of the nodes as well as transport information. The numbering of the steps below refers to the numbering in FIG. 4:
401. The requestor requests the IP address of a server or gateway;
402. The selection logic identifies the requesting host and service parameters required;
403. The selection logic identifies the server or gateway pool;
404. The selection logic identifies the IP address of each relevant pool member;
405. The selection logic identifies information regarding the topology of the pool;
406. The selection logic identifies the status, capability and functionality of the pool members;
407. The selection logic selects the most appropriate pool node; and
408. A message is sent to the requestor including the IP address of the selected node.

Taking each of the above steps in turn, the request for the most suitable gateway/server uses on any type of suitable signalling capable to exchange the required information. In a preferred embodiment, the request is based on a DNS query, because DNS is supported by vast majority of IP hosts, so the impact on requestor functionality is low.

Assuming that a DNS query is used for a gateway/server request, then the service identification is based on a string encoded into the fully qualified domain name (FQDN) of the query, e.g., _inet.tcp.example.net, where _inet denotes the required service, e.g., an Internet connection.

The required Host parameter for the selection is the host's location. This is identified from the requestor's IP address in the case where the Host is the requestor itself. However, if the Host and Requestor are not identical, then the Host identifier is transferred in the DNS query message. This may be done by either of:
The Host identifier is encoded into the FQDN of the DNS request message. For example, for a given Host A the FQDN may look like _HostA_inettcp.example.net. Note that the Host identifier may be any text string that is pre-configured in the selection logic, which is configured to identify the Host from the FQDN. This solution is feasible where static pre-configuration of Hosts and corresponding locations is possible in the Selection logic, and therefore not suitable for mobile or nomadic terminals; and
The Host identifier is transferred as an additional RR field of the DNS query. The Host identifier includes a text string and host's IP address. The IP address identifies the Host's location even for mobile or nomadic hosts. Also note that in this case the selection logic must parse the DNS message to identify the Host.

Turning now to steps 403 and 404, the server or gateway pool for service, and the IP addresses of the members of the pool must be identified. In a preferred embodiment, pool identification for the service is based on standard DNS features, and so the data source for the pools is a standard DNS server. Configuration of the DNS server with the list of selectable nodes for each service is performed by the network management system.

The pool identification comprises the following steps:
A request arrives from the requestor 303 to the selection logic 301;
The selection logic 301 infers the Host and Service parameters as described above, and then issues a standard DNS query to a DNS server 306 specifying the Service required.
The resource records corresponding to the different services are stored in the DNS server 306. Based on the specified Service in the request, the record elements corresponding to the Service including their IP addresses are returned to the selection logic 301 in a DNS-answer.
The selection logic 301 selects a server or gateway from the pool based on the different criteria and sends a response to the requestor 303 containing a single IP address of the selected server or gateway

In a preferred embodiment, the initial request is in a form of a DNS query. This is so that the request may be forwarded by the selection logic 301 to the DNS server 306 with little or no modification of the original request. It is also faster to filter out the most appropriate entry from the answer from the DNS server and transfer it to the requestor.

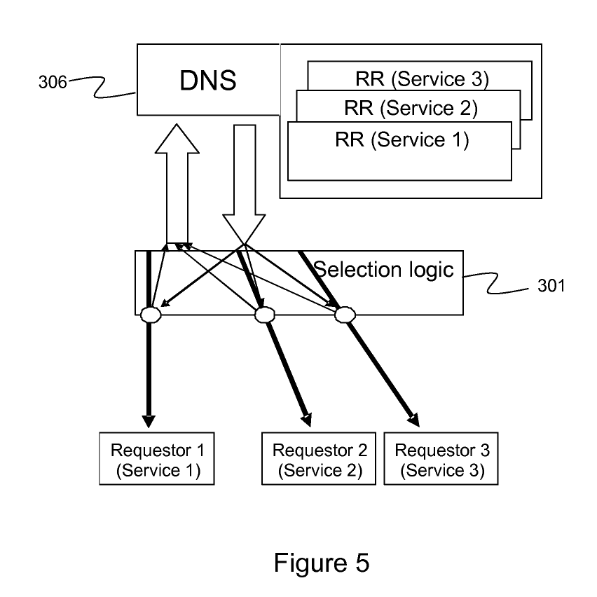

The process of selecting a server or gateway pool is illustrated in FIG. 5.

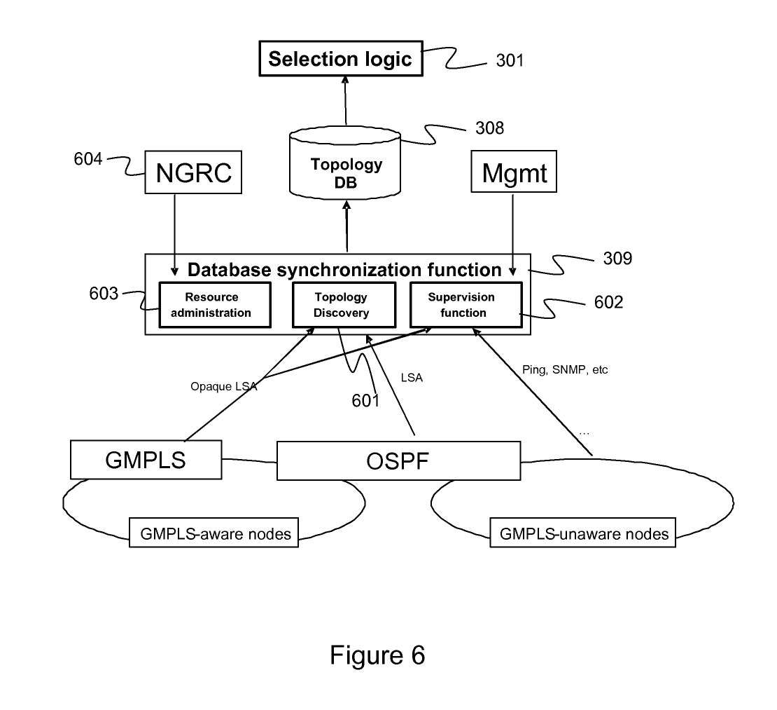

Turning now to step 405, the topology information, as well as status, capability and functionality of pool members, is identified. The data source for the above information is a topology database 308 that is dynamically updated, and the proposed system architecture is illustrated schematically in FIG. 6. The selection logic 301 consults the topology database 308 to find the closest servers/gateways, transport capacity and node status/load information etc. The topology database 308 can be a standard relational database that may be built into the same box as the selection logic 301 but may alternatively be a separate node.

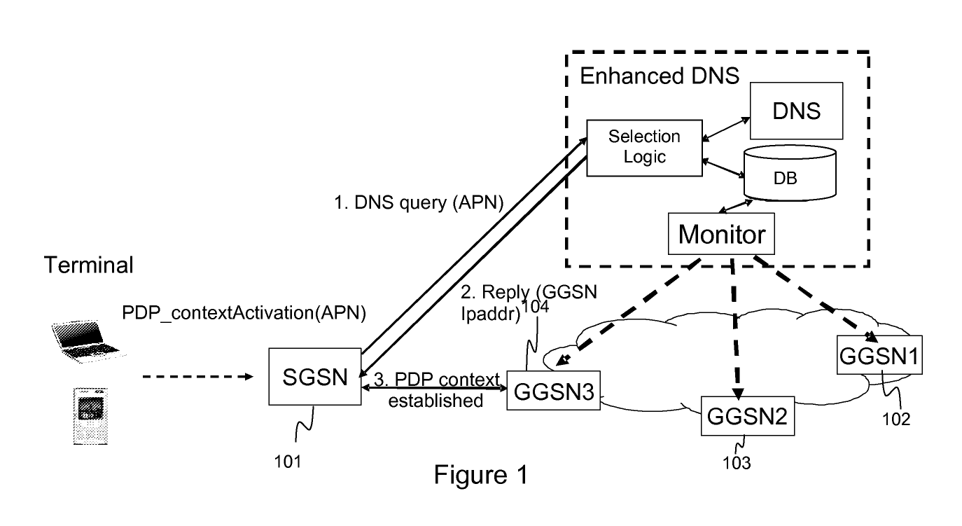

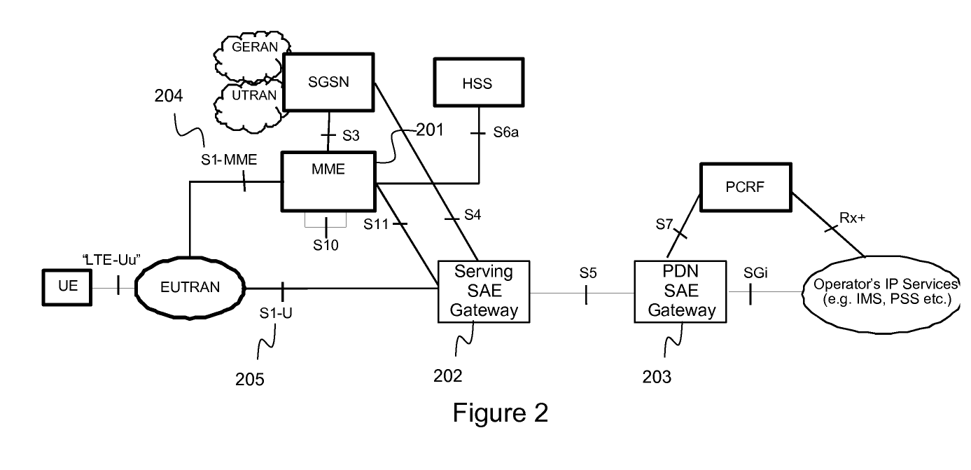

The initial configuration of the database 308 may be done by the management system, such as the O&M system of the mobile network. In order to keep the topology database 308 updated, in a preferred embodiment of the invention a Database synchronization function 309 is provided, as illustrated in FIG. 6. The Database synchronization function 309 has the following main functions:
Topology discovery. The topology discovery function 601 retrieves routing topology and link/router status information by listening to Open Shortest Path First (OSPF) advertisements by routers. The identification of the location of servers and gateways within the topology is performed by any suitable method.
Supervision function. The supervision function 602 is responsible for obtaining the status, capability (e.g., VPN configuration), functionality (e.g., security gateway), and load information of transport nodes as well as pool members. Status, capability, functionality and load information about GMPLS-unaware nodes can be obtained using similar methods as in the solution illustrated in FIG. 1 implemented in IPWorks, e.g. ping, SNMP poll, etc. The supervision function may either interface directly with the relevant nodes or obtain the configuration from a management system that polls the network.
Resource administration. The resource administration function 603 administers the transport resources in order to guarantee a more equilibrated transport load and thus higher session completion ratios. It should be pre-configured by the network management system based on the operator policies, SLA information, etc. Bookkeeping the dynamic changes in the transport resource information may be done by interfacing to a number of entities in order to exchange resource information generically denoted as the Next-Generation Resource Control (NGRC) function in the figure. NGRC may be another logical entity in the network that are in charge of resource management e.g., PCRF, or HSS for retrieving subscription information for a newly attached terminal, but also directly the selection logic that may already have information about the resource needs of the active PDP contexts.

During terminal attachment, a number of relevant SAE-GW scenarios are possible. The following assumes co-located serving and PDN SAEGws, and provides examples of important parameters for selection relevant to each of these scenarios.

In an IMS scenario, an anchor point must be selected to the “closest” GW site to achieve the shortest path with local switching, and so a site location is needed in the anchor point selection.

In a network redundancy scenario, GW-selection is based on an “up-and-running” GW set. Faulty GWs must be blocked and not used in the pool. “Up-and-running” information is required in anchor-point selection, and load information may also optimize the node-capacity usage, and so load information may also be included in anchor-point selection.

In a mobility specific GW/SAEGW scenario, an issue is to reselect a GW based on capability, in order to ensure that a GW that has the capability to deal with, for example, MIP, is used. In this instance, mobility type is used in the anchor point selection.

In Enterprise scenarios, in the situation of an out-door-in scenario in which an in-door network is covered with out-door eNodeBs of a cellular network, Enterprise traffic is routed via the operator backbone, and so an IPSec tunnel is required. In a GW/LTE within an Enterprise network scenario, an in-door network with eNodeBs and a GW is connected to a LAN. There is therefore local switching within the network, and so no need for an IPSec tunnel, but if traffic is routed via the operator network to the Enterprise network, an IPSec tunnel is required. In these scenarios, GW/SAEGW with connectivity to the Enterprise network and GW with IPSec capability should be used in anchor point selection. Furthermore, in certain circumstances, Enterprise-GW should be used in anchor point selection.

Where the Internet is used as a transport network, an IPSec and Denial of Service (DoS) resistant GW is required, and only traffic with a “relaxed” QoS requirement should be sent. Where Internet traffic is forwarded directly to the Internet, the closest GW to “internet peering” parameter should be used in anchor point selection. In addition a DoS resistant GW is required and a GW conforming to particular QoS info may be selected.

In a service specific GW scenario, one GW is provided for all services. An anchor point is selected based on the type of service, and so site location and service information is used in anchor point selection.

In a mobility scenario, the MME forces a GW reselection based on a location change of the user. GW reselection is possible either within or between pools. In this scenario, topology (site location) information is required in anchor point selection.

From the cases described above, the following set of parameters can be derived for SAE GW selection:
Topology related parameters:
   Locations of SAEGW, eNodeB, peering points, POI on geographical and logical i.e., IP topology, as well as actual routing information
Performance related parameters:
   Load/capacity information of SAEGWs
   “Up-and-running”/reachability information about SAEGWs
Capability/Functionality related parameters:
   IP-sec, “DoS-resistant”, Serving/PDN SAEGW etc.
   Mobility type, i.e., supported (3GPP, non-3GPP) accesses
   Connectivity/access to services
      SAEGW with access to Enterprise VPN
      SAEGW within campus/enterprise
      SAEGW with Internet peering
Service related parameters:
   QoS-info and other operator policy information
   Subscription info, e.g., subscribed services, preferred application, service usage statistics etc.

In order to select the most appropriate pool element, specific selection algorithms are required in the selection logic. The selection algorithm is typically different for control plane (server) or user plane (gateway) element selection so the existing algorithms for CP servers may not be directly applicable for gateways. Closeness on the transport topology is often a more important factor for the GW node selection as it provides better characteristics and efficient transport usage, but at the same time, the nodes should be protected from overload.

One way to select an element from the pool is on the basis of load and minimum cost, as follows:

1) Fetch the associated required capability with the APN.
2) Delete any pool-members that are not reachable (“up-and-running”)
3) Delete pool-members that do not fulfil the capability requirements (Security, Qos, IP-sec, Mobility-type etc.)
4) Select pool members that only fulfil requirements of access to expected services (e.g. Enterprise-VPN, Campus, Internet Peering)
5) Calculate the path length (i.e. the number of hops) in the topology database from the RBS.
6) Calculate/map a cost for “good-to-have” capabilities “P” that are not necessary.
7) Calculate cost=(a*Load+b*path_length+c*P), where a, b, and c are arbitrary selected constants.
8) Select the pool-member with minimum cost.

An element may also be selected from a pool on the basis of user subscription. In this case, subscription information can be retrieved from a node that handles user subscriptions, such as an HSS. This allows the use of advanced pooling, examples of which are:

1) Selection restrictions in HSS: For VPN-connection, an APN-can be assigned. An APN can have several IP-addresses i.e. a VPN connection subscriber can be connected to several SAE-GWs. Instead of different configuring each IP-address using the DNS, this can be restricted to limited set of SAE-GWs. One reason to use a restricted set of Pool-members is limitations in key-management for establishment of IP-sec tunnels into the SAE-GWs.
2) “APN in HSS”. To simplify the management, DNS-names are stored in a HSS. In this case, an APN-string from the Mobile Terminal is overridden by the HSS-configured DNS-name. Thus a common APN for a large group of users can be used, and explicit names can be retrieved from HSS.
3) “type of users”: Different subscription can have different restrictions in terms of capacity, rate and mobility. If a subscriber has a fixed-wireless subscription, their mobility is limited, and thus only a local SAEGW need be used. Thus, the HSS, can be have information regarding the DNS-name of the GW.

In the examples above, the following selection algorithm can be applied:

1) Fetch the DNS names from HSS.
2) Fetch the associated required capability with the DNS-name.
3) Delete pool-members that do not fulfil the capability requirements (Security, Qos, Ip-Sec, Mobility-Type Etc.)
4) Select pool members that only fulfil requirements of access to expected services (e.g. Enterprise-VPN, Campus, Internet Peering)
5) Calculate the path length (i.e. the number of hops) in the topology database from the RBS.
6) Calculate/map a cost for “good-to-have” capabilities “P” that are not necessary.
7) Calculate cost=(a*Load+b*path_length+c*P), where a, b, and c are arbitrary selected constants.
8) Select the pool-member with minimum cost.

Once an element has been selected from the pool, the IP address of the selected element is returned by the selection logic in a DNS answer. According to the proposal, the DNS answer will always include a single IP address.

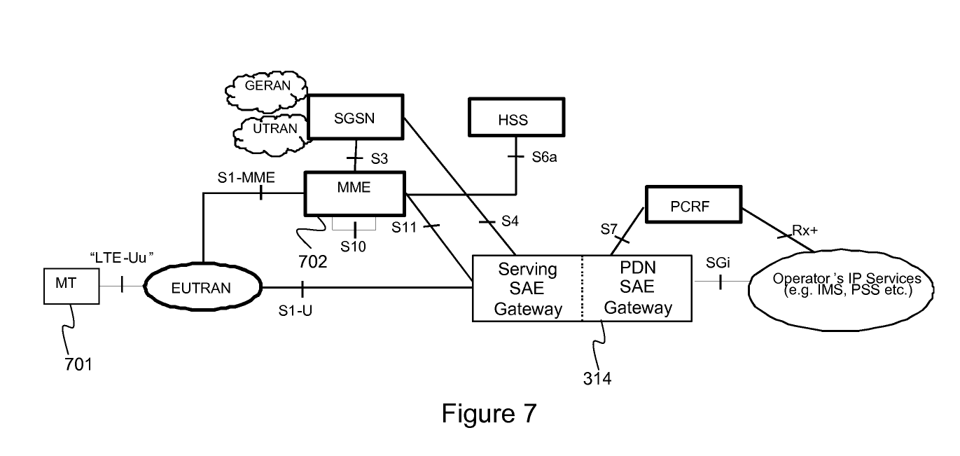

An example of a terminal attachment in a SAE network architecture is illustrated in FIG. 7. Split architecture for the control plane and user plane is assumed, and it is assumed the two types of SAEGW reside in the same physical node, referred to a SAEGW. Note, however, that the SAEGW may alternatively comprise separate Serving and PDN SAEGWs.

When a terminal 701 attaches to the network, the following tasks are performed:
A MME 02 is selected for the terminal 01 by an eNodeB;
The MME selects a SAEGW 314;
The MME selects a SIP server for the MT, i.e., a CSCF

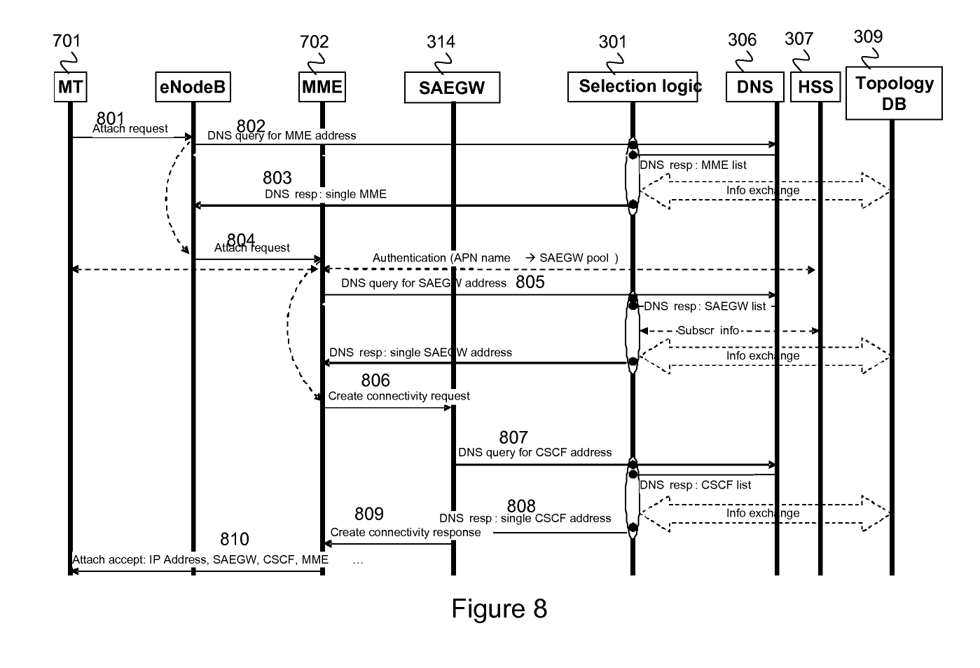

A signalling sequence diagram for terminal 701 attachment including the selection based on the proposed architecture is illustrated in FIG. 8 and includes the following steps:
The terminal 701 issues an attach request to an eNodeB.
eNodeB selects an MME for the given terminal 701. For this, it issues a DNS-query for a MME address
The query arrives at the selection logic 301 that forwards it to the DNS server 306 to obtain a list of potential MMEs for the given service (alternatively, the selection logic maintains a previously received MME list in its cache)
The selection logic 301 selects the most appropriate MME for communication (based on load, availability, etc.), and forwards it in a DNS reply 803 to the eNodeB.
eNodeB issues an attach request 804 to the given MME 702. The MME 1402 initiates an authentication procedure involving the HSS 307. During this process it receives the information about the terminal subscription, e.g., to which PDNs it should be able to connect to. Then, it selects a SAEGW 314 that is able to connect to all these networks. For this, it issues a DNS query 805 specifying the service type that identifies the given SAEGW pool (the APN name may be used for this purpose). In addition, it also specifies the IP address of the eNodeB that issues the attach request in order to provide information about actual terminal 304 location for the selection logic 301.
The selection logic 301 intercepts the query and forwards it to the DNS server to obtain a list of potential SAEGWs for the given service.
The selection logic 301 selects the most appropriate SAEGW 314 for communication and forwards it to the MME in a DNS answer, which in turn initiates a ‘create connectivity’ 806 request to the given SAEGW.
The SAEGW 314 may also select an appropriate CSCF for the terminal 701. For this, it issues a DNS query 807 specifying a parameter that identifies that a CSCF is needed for IMS.
The selection logic 301 intercepts the query and forwards it to the DNS server to obtain a list of potential CSCFs.
The selection logic 301 selects the most appropriate CSCF for communication and forwards it to the SAEGW 314 in a DNS answer 808.
The SAEGW 314 replies 809 to the ‘create connectivity’ request 1506, specifying the selected CSCF among other parameters such as the IP address selected for the terminal 701. The MME 702 forwards these, together with the SAEGW's IP address, to the terminal 701 in an ‘attach accept’ message 810. At this point the terminal 701 is able to use the services provided by the mobile network.

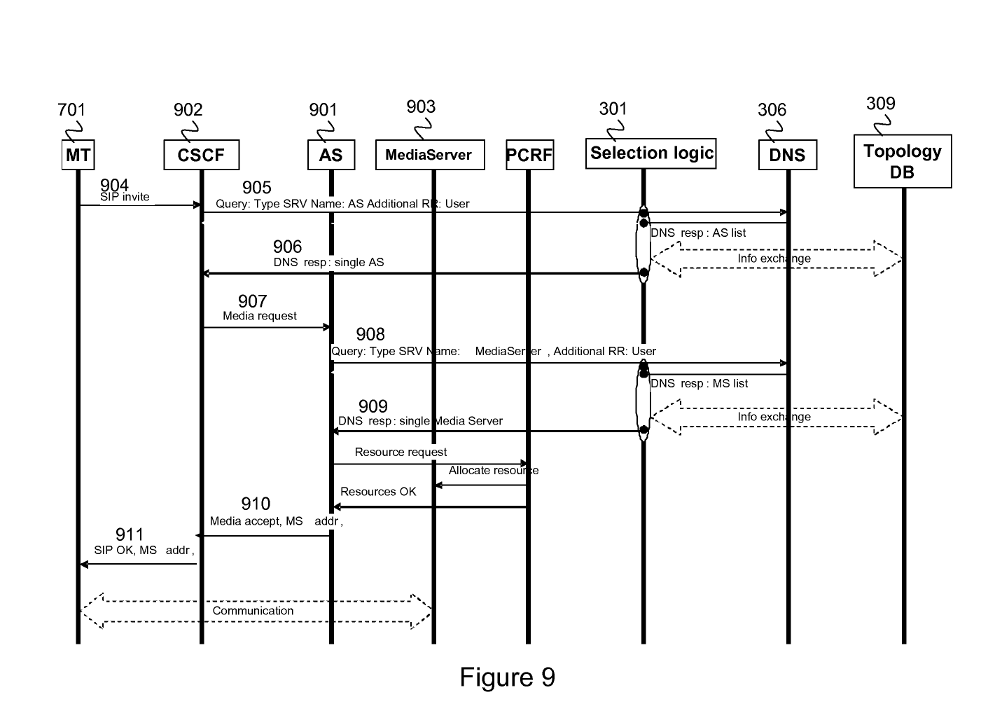

Once the terminal 701 has been assigned a SAEGW 314, other selection tasks are possible during service activation in the service domain, including both control plane server selection and user plane server selection, such as selection of an application server (AS) 901 by a CSCF 902, or selection of a Media Server (MS) 903 by the AS 901. FIG. 9 is a sequence diagram illustrating the selection of a multi-media service, and includes the following steps:
The terminal 701 issues a SIP invite 904 to the previously selected CSCF 902.
The CSCF 902 selects an AS for the given service. For this, it issues a DNS-query 905 specifying optionally the terminal's 701 IP address to select a closer AS (since AS is mostly a control server this may not be necessary).
The query arrives at the selection logic 301 that forwards it to the DNS server 306 to obtain a the list of potential ASs for the given service (alternatively, it could keep a previously received AS list in its cache.
The selection logic 301 selects the most appropriate AS 901 for communication, and forwards it in a DNS reply 906 to the CSCF 902.
The CSCF 902 issues a media request 907 to the AS 901. The AS 901 selects a Media Server 903 for the service. For this, it issues a DNS query 908 specifying the service type that identifies the Media Server pool. In addition, it also specifies the IP address of the terminal 701.
The selection logic 301 intercepts the query and forwards it to the DNS server 306 to obtain a list of potential Media Servers for the given service.
The selection logic 301 selects the most appropriate Media Server for communication and forwards it to the AS 901 in a DNS answer 909, which in turn forwards it to the CSCF 902 in a Media Accept message 910.
The CSCF 902 forwards the Media Server address to the terminal 701 in a SIP ok message 911, and the communication can start.

The invention is not limited to the cases discussed above, but may be used in other potential selection scenarios in SAE. One example is support for SAEGW relocation in mobile terminal idle mode. It can be useful to re-select a SAEGW in some situations, for example to achieve 51 path optimization for a mobile user. If the SAEGW pool size is small then the S1 path may not be too large, but on the other hand user mobility could often cause SAEGW relocation, which may affect ongoing sessions and may consume scarce control resources. In the case of an idle terminal and available control resources, it would be desirable to support SAEGW re-location by selecting a SAEGW.

The selection logic may help also in the selection of a proper local PDN SAEWG as an IP POP for a roaming user for optimized network usage (local breakout)

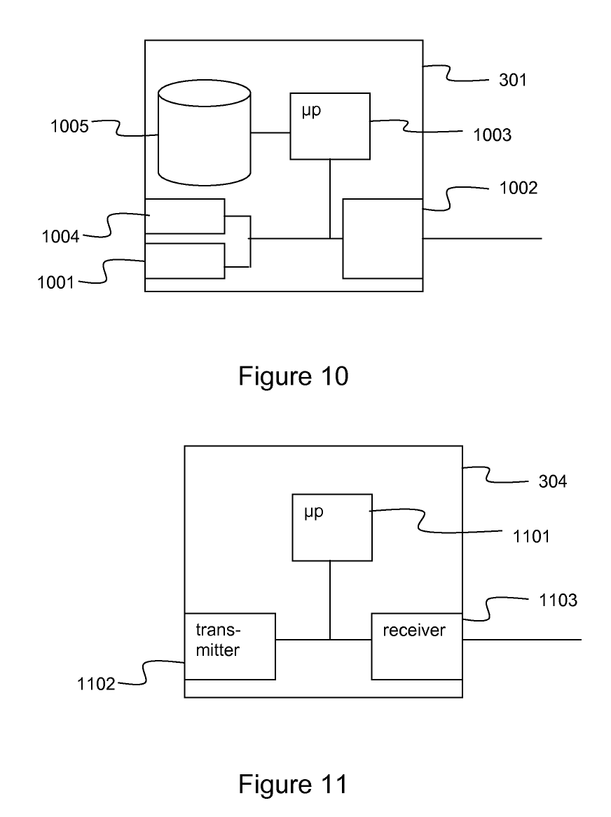

Referring to FIG. 10, there is illustrated a selection logic function node 301. Means for receiving 1001 a DNS request for a gateway or server are provided, along with means for retrieving 1002 information from other sources such as a DNS server, HSS and topology database, as described above. A processor 1003 is provided to make a selection of the gateway or server, and a transmitter 1004 is provided for sending a response message to the requestor. A database 1005 may be provided in order to maintain a record of which server or gateway has been selected.

Referring to FIG. 11, there is illustrated a terminal according to an embodiment of the invention. The terminal 304 has a processor 1101 for generating a DNS query for requesting a network resource such as a server or gateway. The DNS query includes the type of network resource required encoded in a Fully Qualified Domain Name. The terminal also has a transmitter 1102 for sending the query, and a receiver 1103 for receiving a response to the query.

The invention provides a common architecture (single central logic) for selection of an element from a pool of elements, instead of having the selection logic implemented and configured in different control nodes. This reduces capital and operating expenditure, as there is no need to implement and configure selection-related functionality in all different logical nodes that may be in charge of selection from a pool of gateways or servers in the network. Operating expenditure reduction is especially manifested in a number of use cases (network extension, maintenance etc.) for which the centralized selection gives better support.

Another advantage of the invention is that it is based on standard DNS queries, so it does not require significant changes to the existing node functions and signalling chains. In most cases, all IP hosts support DNS. Compared to the DNS-based selection, the present invention allows for a fully topology-aware selection by using the topology database that provides:
An efficient transport usage by using transport load information in the selection. This is especially useful in since the penetration of mobile terminals as well as activity of users in certain regions may dynamically change.
Better characteristics of call/session setup times and completion ratios due to true knowledge of server/gateway reachability and available transport resources
Improved response times and characteristics for the QoS-sensitive services due to choosing the shortest possible user plane path and service node with the lightest load

Architectural enhancements allow the possibility of implementing DNS-based selection for the cases when the DNS requestor and the communicating host are not the same (e.g., SAEGW selection for a newly attached MT by the MME). Furthermore, automated management of pool configuration is provided for a given service by dynamic knowledge of node capability, status and functionality-related information in the topology database via Opaque LSAs. A number of important scenarios may be supported, like plug-n-play, network failures or network upgrades.

Although various embodiments have been shown and described in detail, the claims are not limited to any particular embodiment or example. None of the above description should be read as implying that any particular element, step, or function is essential such that it must be included in the claims' scope. The scope of patented subject matter is defined by the claims.

The following acronyms are used in this specification:

### 3GPP 3rd Generation Partnership Project

### BGP Border Gateway Protocol

### CSCF Call Session Control Function

### GGSN Gateway GPRS Support Node

### LTE Long Term Evolution

### MME Mobile Management Entity

### MSC Mobile Switching Centre

### MT Mobile Terminal

### NT Nomadic Terminal

### OSPF Open Shortest Path First Protocol

### PDA Personal Digital Assistant

### PDN Packet Data Network

### POP Point of Presence

### RNC Radio Network Controller

### SAE System Architecture Evolution

SGSN Serving GPRS Support Node

1-20. (canceled)

21. A method for selecting a network resource from a plurality of network resources in a communications network, the method comprising:
at a selection node, receiving from a terminal a request for a network resource;
retrieving, from a dynamically updated database, data relating to the status and capabilities of each network resource of the plurality of network resources;
on the basis of the retrieved data, selecting a network resource from the plurality of network resources; and
sending a response to the terminal, the response including information identifying the selected network resource.

22. The method of claim 21, wherein the retrieved data is selected from the group consisting of a topology of each network resource in the network, a current load on each network resource, and a current capacity of the network on a path between the terminal and the network resource.

23. The method of claim 21, further comprising retrieving, from a Domain Name Server, an address for each network resource of the plurality of network resources.

24. The method of claim 21, further comprising retrieving, from a Home Subscriber Server, subscription and service information relating to a user or the terminal.

25. The method according of claim 21, wherein the request and the response are Domain Name System messages.

26. The method of claims 21, wherein selecting a network resource from the plurality of network resources comprises discounting those network resources from the plurality of network resources that do not fulfill requirements of reachability or available services.

27. A selection node operable in a communications network including a plurality of network resources, the selection node comprising:
a receiver operative to receive a request from a terminal for a network resource;
a retriever operative to retrieve, from a dynamically updated database, data relating to the status and capabilities of each network resource of the plurality of network resources;
a selector operative to select a network resource from a plurality of network resources on the basis of the retrieved data; and
a transmitter operative to send a message to the terminal, the message including information identifying the selected network resource.

28. The selection node of claim 27, wherein the retriever is operative to retrieve data from a plurality of network nodes.

29. The selection node of claim 27, wherein the selected network resource is one of a server or gateway function.

30. The selection of claim 27, wherein the retrieved data is selected from the group consisting of a topology of each network resource in the network, a current load on each network resource, and a current capacity of the network on a path between the terminal and the network resource.

31. The selection node of claim 27, wherein the retrieved data comprises information selected from the group consisting of:
a location on the network of each of the plurality of network resources;
routing information for each of the plurality of network resources;
current load on each of the plurality of network resources;
current capacity of each of the plurality of network resources;
current network capacity on a path between the terminal and each of the plurality of network resources;
security information relating to each of the plurality of network resources;
services available from each of the plurality of network resources;
subscription information relating to a user or the terminal; and
operator policy information.

32. The selection node of claim 27, wherein the selector is further operative to discount those network resources from the plurality of network resources that do not fulfill requirements of reachability or available services.

33. The selection node of claims 27, wherein the selector is further operative to balance the load on network resources of the plurality of network resources.

34. A terminal operative in a communications network, the terminal comprising:
a processor operative to generate a request message for a network resource, the request message comprising a Domain Name System query, the Domain Name System query further comprising the identity of the terminal encoded in a Fully Qualified Domain Name.

35. A computer readable medium including program instructions operative to cause a processor at a selection node in a communications network including a plurality of network resources to perform the following steps:
receiving from a terminal a request for a network resource;
retrieving, from a dynamically updated database, data relating to the status and capabilities of each network resource of the plurality of network resources;
on the basis of the retrieved data, selecting a network resource from the plurality of network resources; and
sending a response to the terminal, the response including information identifying the selected network resource.
